(19) United States
(12) Patent Application Publication
(10) Pub. No.: US 2012/0249468 A1
(43) Pub. Date: Oct. 4, 2012

(54) Virtual Touchpad Using a Depth Camera

(75) Inventor: Jeffrey Brian Cole, Seattle, WA (US)

(73) Assignee: Microsoft Corporation, Redmond, WA (US)

(21) Appl. No.: 13/079,373

(22) Filed: Apr. 4, 2011

(51) Int. Cl. G06F 3/045

(52) U.S. Cl. 345/174

(57) ABSTRACT

The subject disclosure is directed towards a virtual touchpad comprising a region in space positioned relative to a detected user with which a user interacts by hand movements as determined from frames of depth data obtained via a depth camera. The user's hand position or positions in the virtual touchpad region may be converted to coordinates, such as for posting to a message queue for use by an application. The computing device and depth camera may be incorporated into a robot that moves on a floor, with the depth camera angled upwardly and the virtual touchpad region tilted to facilitate user interaction.

### BACKGROUND

Interacting with a computing device, such as a computer, game system or robot, without requiring an input device such as a keyboard, mouse, touch-sensitive screen or game controller, presents various challenges. For one, the device needs to determine when a user is interacting with it, and when the user is doing something else. There needs to be a way for the user to make such an intention known to the device.

For another, users tend to move around. This means that the device cannot depend upon the user being at a fixed location when interaction is desired.

Still further, the conventional way in which users interact with computing devices is via user Interfaces that present options in the form of menus, lists, and icons. However, such user interface options are based upon conventional input devices. Providing for navigation between options and for selection of discrete elements without such a device is another challenge.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which depth data obtained via a depth camera is processed to provide a virtual touchpad region in which a user can use hand movements or the like to interact with a computing device. A virtual touchpad program processes the depth data to determine a representative position of a user, e.g., the user's head position, and logically generates the virtual touchpad region relative to the representative position. Further processing of the depth data indicates when and where the user interacts with the virtual touchpad region, with the interaction-related depth data processed to determine corresponding input data (e.g., coordinates), such as for posting to a message queue.

In one aspect, the representative position of the user is determined based at least in part on face detection. This helps facilitate tracking multiple users in a scene, although it is also feasible to do so based upon tracking head position only.

In one aspect, the computing device and depth camera are incorporated into a robot that moves on a floor. The depth camera may be angled upwardly relative to the floor to detect the user, and the dimensions of the virtual touchpad region may be logically generated to vertically tilt the virtual touchpad region relative to the floor.

To determine hand position within the virtual touchpad region, one or more connected blobs representing objects in the virtual touchpad region are selected, as detected via the depth data. Hands may be isolated from among the blobs by blob size, as well as by blob position by eliminating any blob that touches any horizontal or vertical edge of the virtual touchpad region. In general, this detects intentional physical projection by the user of one or more objects (e.g., hands) into the virtual touchpad region. A coordinate set that represents each hand's position within the virtual touchpad region may be computed, e.g., based upon a center of energy computation.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a representation of a user interacting with a virtual touchpad region that is logically generated via depth camera data.

FIG. 2 is a block diagram representing example components configured to use depth camera data to provide for interaction via a virtual touchpad.

FIG. 3 is a representation of an image captured by a depth camera representing user interaction with a virtual touchpad region.

FIG. 4A is a representation of data blobs that correspond to depth data representing objects in the virtual touchpad region.

FIG. 4B is a representation of the data blobs of FIG. 4A that remain after processing the depth data in the virtual touchpad region, in which the remaining data blobs represent user hands present in the virtual touchpad region.

FIG. 5 is a flow diagram showing example steps directed towards capturing and processing a frame of data captured by a depth camera to provide for device interaction via a virtual touchpad.

FIG. 6 is a block diagram representing an exemplary non-limiting computing system or operating environment in which one or more aspects of various embodiments described herein can be implemented.

### DETAILED DESCRIPTION

Various aspects of the technology described herein are generally directed towards a virtual touchpad that is programmatically positioned in front of users, allowing them to reach out and move their hands to interact with a computing device. For example, hand movement within the virtual touchpad region may be used to provide input to the computing device, such as to control movement of one or more correlated cursors about a displayed representation of a user interface. The input may be used by the device to select between options and make selections, including operating as if the input came from a conventional input device.

It should be understood that any of the examples herein are non-limiting. For one, while one computing device is exemplified as a robot, it is understood that any computing and/or electronic device, such as a personal computer, television, game system, and so forth may benefit from the technology described herein. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and interfacing with computing and/or electronic devices in general.

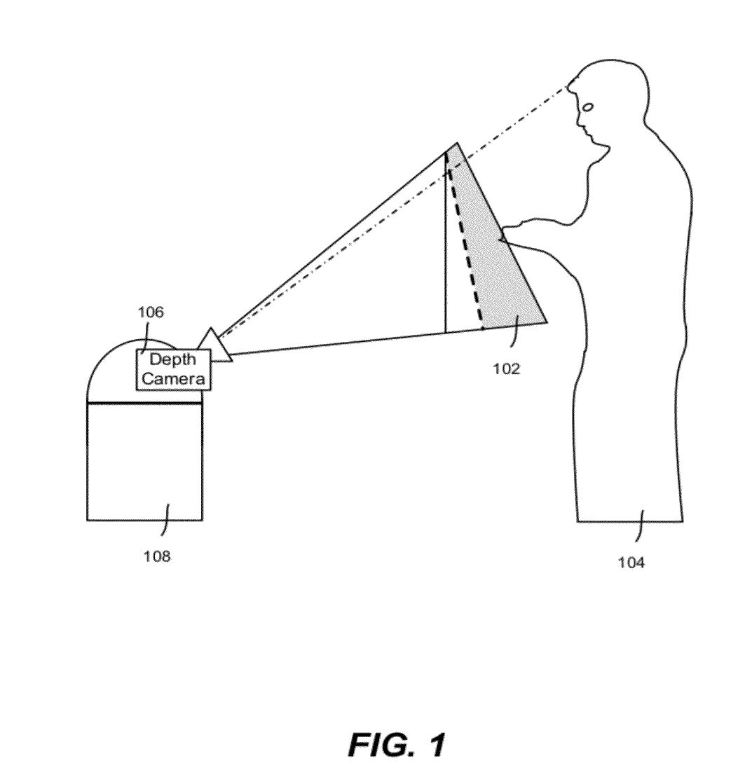

FIG. 1 shows a general conceptual example of a virtual touchpad 102 comprising a three-dimensional volumetric region (represented by the two-dimensional shaded area in FIG. 1) being interacted with by a user 104. Note that the virtual touchpad 102 may be tilted, e.g., the dark dashed line is the result of a computationally adjusted interaction plane. In this example implementation, a depth camera 106 coupled to a robot 108 provides information about the user's position, including the user's hand positions, and thereby senses interaction with the virtual touchpad 102.

As will be understood, the depth camera 106 provides an image including depth data that may be processed to determine relative user position (e.g., user head position), which may be used to determine where in space to position the virtual touchpad 102. As will be understood, the virtual touchpad region does not physically exist as an object, but rather is logically generated in space as a set of two or three-dimensional coordinates relative to a representative position of the user, with interaction with the virtual touchpad detected based upon information in the depth data at the corresponding virtual touchpad image pixel coordinates.

In addition, (or alternatively), the RGB data of the depth camera 106 may be used for face detection (and/or face recognition). Note that the exemplified depth camera 106 is configured to provide R, G, B and D (depth) values per pixel, per frame; however if RGB data is desired, it is also feasible to use data captured by an RGB camera in conjunction with a separate depth camera that only provides depth data. Face detection is advantageous when a person's head may otherwise be considered a background object rather than a foreground object, such as if the person is keeping his or her head very still. Face detection also helps differentiate multiple persons in a scene.

As will be described below, the depth data is further processed to determine where the user's hands in the foreground are located relative to the virtual touchpad 102, which if present in the virtual touchpad region, may then be converted into x, y, z coordinates, e.g., on a per-frame basis. As will be understood, this is accomplished by tracking the hand positions when they intersect the virtual touchpad, and thus may be performed without the high computational power that is needed to interpret the user's body and construct a representational skeleton of the user in order to track the user's motions and body positions (e.g., as in Microsoft® Kinect™ technology).

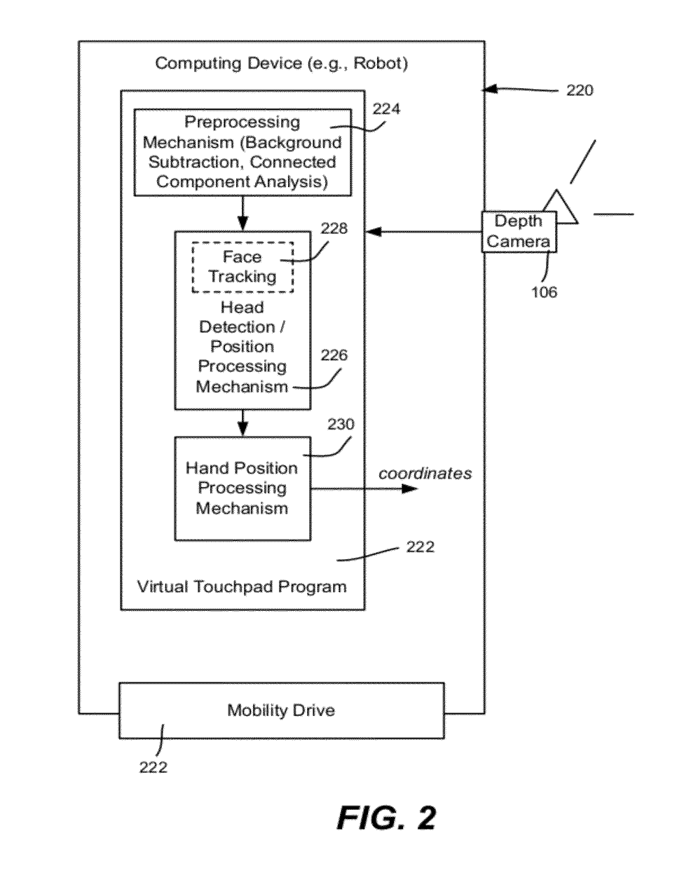

FIG. 2 shows components of one example implementation in which a computing device in the form of a moveable robot 220 has a depth camera 106 coupled thereto. In general, the robot 220 is a relatively low height device and is mobile, as represented by the mobility drive 221, and thus travels on the ground. As a result, the depth camera 106 (which may be moveable) is ordinarily angled upwards to view the user. Note that because the camera/robot is moveable, including angularly, there is no need for left/right tilting of the virtual touchpad 102; however computational left/right tilting of the virtual touchpad may be performed, such as for implementations where the depth camera is horizontally fixed, or if at least one other virtual touchpad is available (for multiple users; note that in an appropriate scenario such as game playing or collaboration, more than one user may be provided with a virtual touchpad).

As represented in FIG. 2, the computing device/robot 220 includes a virtual touchpad program 222 (e.g., computer logic or the like) that receives depth data from the depth camera 106. The exemplified virtual touchpad program 222 includes a preprocessing mechanism 224 that performs some processing on the data, such as background subtraction, a known technique for separating the background from the foreground by evaluating whether any captured pixel gets closer (has less depth). More particularly, by keeping track of the furthest depth value sensed for each pixel in the image, the mechanism is able to quickly detect when an object has moved into the foreground of the scene. Note that to be considered as having moved sufficiently closer, a foreground threshold/change level may be used, which helps eliminate noisy depth readings. Further note that if the robot moves, the background subtraction process may be reset with newly recaptured values.

Following background subtraction, connected component analysis (another known computer vision technique) is performed to determine groups of pixels that are connected. In general, background subtraction and connected component analysis separates each region of the image where the depth reading is closer than previous readings, and segments the image into foreground and background blobs representing foreground objects.

In one implementation, measurements are made on one or more foreground objects to determine whether a user's head is in the depth camera's field of view. To this end, the array (the pixel map comprising columns and rows) is processed by a head detection/position processing mechanism 226 from the top pixel row downward to determine leftmost and rightmost points of any object in the depth image; note that it is straightforward to determine horizontal (and vertical) distances from depth data. If the distance between the left and right side of an object is of a width that corresponds to a reasonable human head (e.g., between a maximum width and a minimum width), then the object is considered a head. If a head is not detected, then the next lower pixel row of the array is similarly processed and so on, until a head is detected or the row is too low. In other words, when foreground blobs are sufficiently large and a head-shaped blob is detected at the top of the region, then the region is tracked as a user for subsequent frames. Note that while more complex processing may be performed, this straightforward process is effective in actual practice.

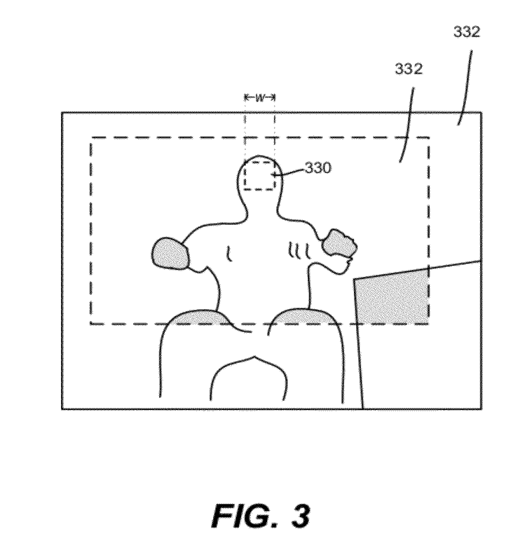

FIG. 3 shows an example where a head is detected based on its width w and is represented by a square box 330 corresponding to that width. The position of the head may be tracked over multiple frames by the position of the box 330 (e.g., represented by a center point). The distance to the user's head may be computed from the various depths within that square box, e.g., an average depth may be computed as the distance to the user's head. In this way, the x, y and z coordinates representative of the head are known, e.g., x and y via the center point, and z via the average depth.

In a situation in which multiple users appear, the change in the location of each box that represents a head may be tracked. In this way, the head detection/position processing mechanism 226 (FIG. 2) may track which user is which, because a head can only reasonably move so much in the time taken to capture a frame, e.g., within an allowed padded region/normal distribution. A list of a primary user (the one provided with a virtual touchpad, such as the closest one) and one or more unknown people may be maintained. A confidence threshold may be used, e.g., to be considered a head, the same object has to be detected within a somewhat larger surrounding area (the “padded” region) over a threshold number of frames.

In one embodiment, face tracking 228 (FIG. 2) may be used to determine when and where a user's head appears. As is known, face tracking is able to detect faces within RGB frames, and based on those coordinates (e.g., of a rectangle logically generated around the face), a distance to the head may be computed from the depth data. Face tracking also may be used to differentiate among different users in an image when multiple users appear. For purposes of brevity herein, a single user will be mostly described, except where otherwise noted.

Turning to another aspect, once the representative position of the user (e.g., the head position) is known, the position of the virtual touchpad 102 may be computed relative to that position, such as a reasonable distance (e.g., approximately one-half meter) in front of and below the head, with any tilting accomplished by basic geometry. The virtual touchpad 102 is thus created relative to the user, and may be given any appropriate width, height, and depth, which may vary by application. For example, if the device is at a lower surface than the user (facing up at the user), the pad may be angled to the user's body such that the penetration points are aligned to the person's body, not to the orientation of the device. This helps the user to intuitively learn that the touch pad is directly in front of him or her, no matter what the circumstance of the device with which the user is interacting.

In general, the virtual touchpad follows the head throughout the frames. Note that while the user is interacting with the virtual touchpad as described below, the virtual touchpad may be fixed (at least to an extent), e.g., so that unintentional head movements do not move the virtual touchpad relative to the user's hand positions. As long as the user is tracked, any object penetrating this region (which may be a plane or volume) is checked to determine if it should be interpreted as the user's hand; if so the hand's positional data is tracked by the device.

FIG. 3 represents a front view of one such virtual touchpad 332 (represented by the dashed block) virtually placed within the overall image 334. The shaded areas represent objects in the virtual touchpad region. As can be seen, in this example the virtual touchpad 332 is wider than the user's shoulder width, and extends vertically from just above the head to just below the top of the (seated) user's knees.

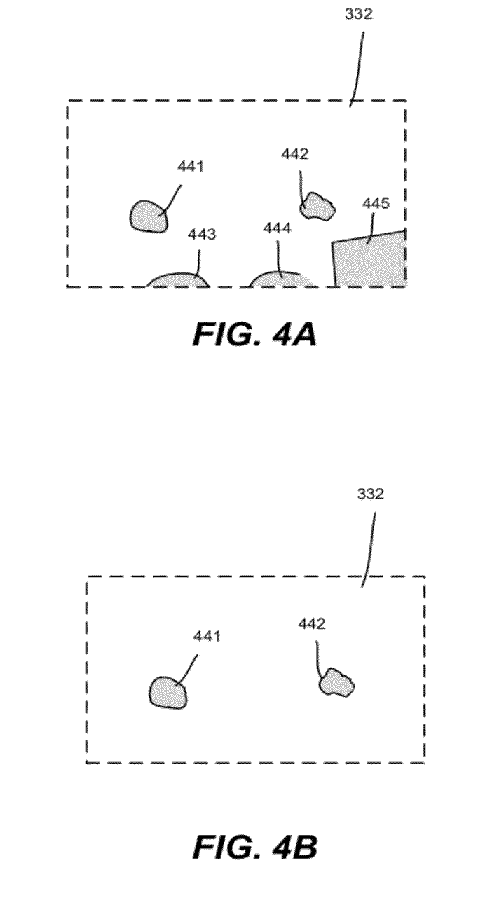

Once positioned, any objects within the virtual touchpad 332 may be isolated from other objects based upon their depths being within the virtual touchpad region, as represented in FIG. 4A by the various blobs 441-445. As represented in FIG. 4B, only those blobs that are not touching the border (one or more of the edges) of the virtual touchpad, e.g., island blobs 441 and 442, are considered as being intentionally extended by the user into the virtual touchpad region. Thus, the user's knees (corresponding to blobs 443 and 444) and the object (e.g., desk corner) 445 are not considered hands, and only the blobs 441 and 442 remain.

In the event that more than two such island blobs exist in the virtual touchpad, the two largest such blobs are selected as representing the hands. It is alternatively feasible to eliminate any extra blob that is not of a size that reasonably represents a hand.

In one implementation, the coordinates that are selected to represent the position of each of the hands (blobs 441 and 442) are computed based upon each blob's center of energy computation. A center of mass computation is also feasible, as one alternative way to determine coordinates, for example, however with the center of energy, a user who is pointing a finger into the virtual touchpad will generally have the coordinates follow the fingertip because it has the closest depth values.

The coordinates may be provided in any suitable way to an application or other program, such as by posting messages to a message queue with an accompanying timestamp. Note that if the z-coordinates are discarded, the virtual touchpad operates like any other touchpad, with two coordinate pairs able to be used as cursors, including for pinching (zoom out) or spreading (zoom in) operations; however, the z-coordinate may be retained for applications that are configured to use three-dimensional cursors. Similarly, only a single coordinate set (e.g., corresponding to the right hand, which may be user configurable) may be provided for an application that expects only one cursor to be controlled via conventional single pointing device messages.

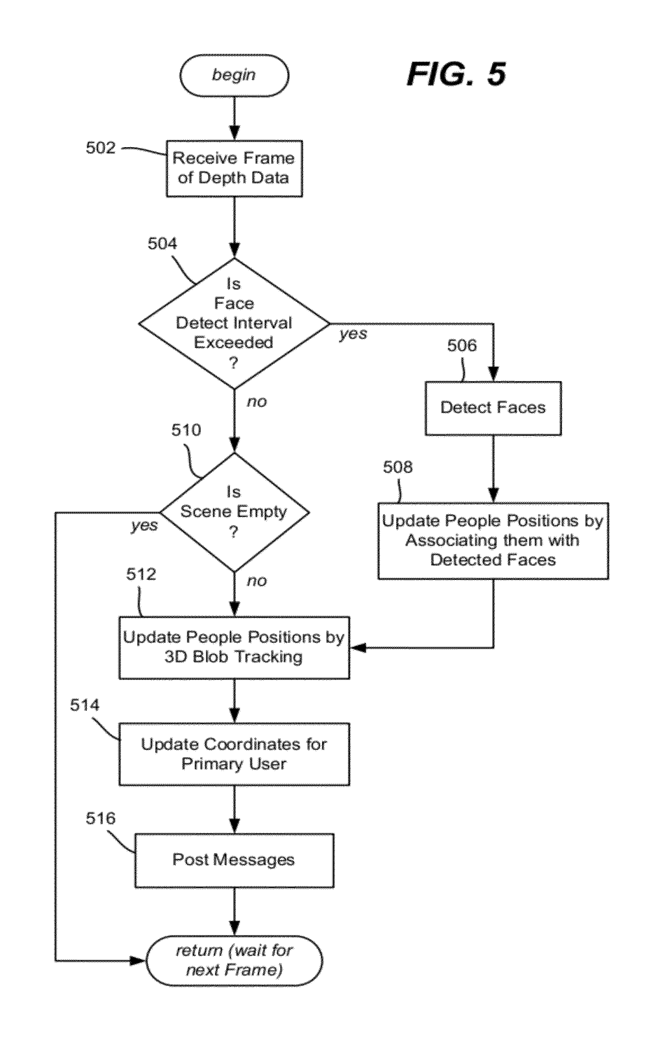

FIG. 5 is a flow diagram summarizing some of the example steps in one implementation process that uses face detection as well as blob-based head detection, beginning at step 502 where the depth data for a frame is received. Face detection need not be performed every frame, and thus step 504 represents a step in which face detection is only performed at an appropriate interval, e.g., some fixed time such as twice per second or every so many frames. When the interval is reached, step 506 detects the face or faces, and step 508 updates the people positions by associating each of them with a detected face. Note that if no face is detected, step 506 can await the next face detection interval, which may be a shorter interval when no faces are detected, even as often as every frame.

Step 510 is performed after face detection (or if not yet time for face detection), in which the scene is evaluated to determine whether it is empty with respect to users. If so, the process ends for this frame. Otherwise, step 512 determines the head position or positions. Step 514 updates the coordinates for each user based on the hand or hands, if any, in the virtual touchpad region, which in one implementation is only performed for the primary user. Step 516 represents outputting the coordinates in some way, e.g., by posting messages for use by an application or the like. Note that instead of coordinates, some pre-processing may be performed based upon the coordinates, e.g., the movements may be detected as gestures, and a command provided to an application that represents the gesture.

As can be seen, there is described a technology for receiving controller-free user input without needing high-computational expenditure. By analyzing a depth image to see if there are objects of interest that may be people, and logically creating a virtual touch pad in front of at least one person that is sensed for interaction therewith, controller-free interaction using only hand movements or the like is provided.

### EXEMPLARY COMPUTING DEVICE

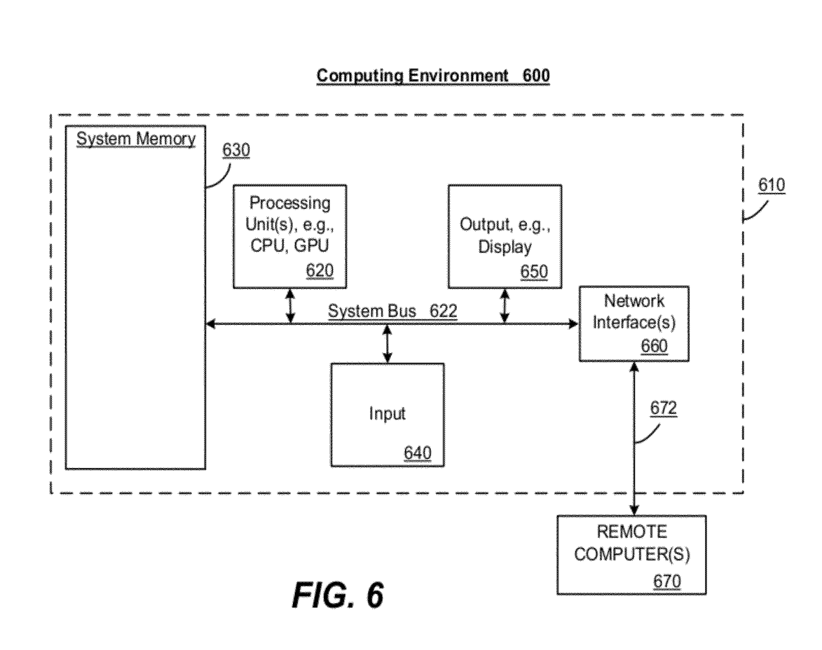

As mentioned, advantageously, the techniques described herein can be applied to any device. It can be understood, therefore, that handheld, portable and other computing devices and computing objects of all kinds including robots are contemplated for use in connection with the various embodiments. Accordingly, the below general purpose remote computer described below in FIG. 6 is but one example of a computing device.

Embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 6 thus illustrates an example of a suitable computing system environment 600 in which one or aspects of the embodiments described herein can be implemented, although as made clear above, the computing system environment 600 is only one example of a suitable computing environment and is not intended to suggest any limitation as to scope of use or functionality. In addition, the computing system environment 600 is not intended to be interpreted as having any dependency relating to any one or combination of components illustrated in the exemplary computing system environment 600.

With reference to FIG. 6, an exemplary remote device for implementing one or more embodiments includes a general purpose computing device in the form of a computer 610. Components of computer 610 may include, but are not limited to, a processing unit 620, a system memory 630, and a system bus 622 that couples various system components including the system memory to the processing unit 620.

Computer 610 typically includes a variety of computer readable media and can be any available media that can be accessed by computer 610. The system memory 630 may include computer storage media in the form of volatile and/or nonvolatile memory such as read only memory (ROM) and/or random access memory (RAM). By way of example, and not limitation, system memory 630 may also include an operating system, application programs, other program modules, and program data.

A user can enter commands and information into the computer 610 through input devices 640. A monitor or other type of display device is also connected to the system bus 622 via an interface, such as output interface 650. In addition to a monitor, computers can also include other peripheral output devices such as speakers and a printer, which may be connected through output interface 650.

The computer 610 may operate in a networked or distributed environment using logical connections to one or more other remote computers, such as remote computer 670. The remote computer 670 may be a personal computer, a server, a router, a network PC, a peer device or other common network node, or any other remote media consumption or transmission device, and may include any or all of the elements described above relative to the computer 610. The logical connections depicted in FIG. 6 include a network 672, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts may be applied to any network system and any computing device or system in which it is desirable to improve efficiency of resource usage.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described herein, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. In a computing environment having a computing device, a system comprising, a depth camera configured to capture depth data, a virtual touchpad program coupled to or incorporated into the computing device, the virtual touchpad program configured to process the depth data to determine a representative position of a user, and to process the depth data to determine coordinates, the coordinates based upon information in the depth data indicative of user interaction with a virtual touchpad region logically generated relative to the representative position of the user.

2. The system of claim 1 wherein the virtual touchpad program is configured to perform background subtraction to separate one or more foreground objects, including at least part of the user, from background information.

3. The system of claim 1 wherein the virtual touchpad program is configured to perform connected component analysis to determine one or more foreground objects.

4. The system of claim 1 wherein the representative position of the user is determined based at least in part on face detection.

5. The system of claim 1 wherein the representative position of the user is determined based on detecting head position, including determining x, y and z coordinates representative of the head position.

6. The system of claim 1 wherein the computing device and depth camera are incorporated into a robot that moves on a floor, wherein the depth camera is angled upwardly relative to the floor to detect the user, and wherein the dimensions of the virtual touchpad region are logically generated to vertically tilt the virtual touchpad region relative to the floor.

7. The system of claim 1 wherein the virtual touchpad program includes a hand position processing mechanism configured to determine the coordinates corresponding to one or more user hands extending into in the virtual touchpad region based upon one or more connected blobs representing objects in the virtual touchpad region as detected via the depth data.

8. The system of claim 7 wherein the hand position processing mechanism determines the one or more hands from among a plurality of the blobs by eliminating any blob that touches any horizontal or vertical edge of the virtual touchpad region.

9. The system of claim 1 wherein the virtual touchpad program posts at least some of the coordinates as messages to a message queue.

10. In a computing environment, a method performed at least in part on at least one processor, comprising:
receiving frames of depth data from a depth camera;
processing the depth data to determine a representative position of a user;
computing a virtual touchpad region relative to the representative position of the user;
detecting interaction with the virtual touchpad region based upon detecting, via the frames of depth data, physical projection of one or more objects into the virtual touchpad region; and
using the interaction to provide input to a computer program.

11. The method of claim 10 further comprising, using face detection as part of determining the representative position of the user.

12. The method of claim 10 wherein one of the objects comprises a hand of the user, and further comprising, determining a coordinate set that represents the hand's position within the virtual touchpad region.

13. The method of claim 12 wherein the coordinate set is computed based upon a center of energy computation, and further comprising, processing the depth data to detect the hand from among blobs corresponding to information in the depth data, including detecting the hand using blob size and blob position relative to the virtual touchpad region.

14. The method of claim 10 further comprising, tracking the representative position of the user over a plurality of the frames.

15. The method of claim 10 further comprising, tracking information corresponding to another user captured in the depth camera view.

16. One or more computer-readable media having computer-executable instructions, which when executed perform steps, comprising:
capturing frames of depth data via a depth camera, the depth data representative of a scene;
processing the depth data to separate any foreground information from scene background information, and to determine one or more foreground objects connected as blobs in the foreground information;
detecting at least part of a user corresponding to a foreground object;
determining a representative position of the user;
logically generating a virtual touchpad region relative to the representative position, the virtual touchpad based upon a two-dimensional or three-dimensional region in space in the depth camera field of view;
processing the depth data to detect user movements within the virtual touchpad region; and
outputting coordinates corresponding to the user movements.

17. The one or more computer-readable media of claim 16 wherein detecting at least part of a user corresponding to a foreground object comprises detecting a user head or face, or both a user head and face.

18. The one or more computer-readable media of claim 16 having further computer-executable instructions comprising, isolating the user movements from any other foreground object that exists in the virtual touchpad region by not considering foreground objects that touch a horizontal or vertical edge of the virtual touchpad region.

19. The one or more computer-readable media of claim 16 wherein the depth data comprises a two-dimensional map of columns and rows, and wherein detecting at least part of a user corresponding to a foreground object comprises detecting a user head by processing the depth data from a top row downwards to determine a foreground object having a width that corresponds to a reasonable human head width.

20. The one or more computer-readable media of claim 16 wherein outputting coordinates corresponding to the user movements comprise posting messages into a message queue, each message comprising at least two coordinates.
